(19) United States
(12) Patent Application Publication
(10) Pub. No.: US 2013/0164447 A1
(43) Pub. Date: Jun. 27, 2013

(54) METHOD FOR MANUFACTURING MATERIAL OF ENERGY PRODUCT

(71) Applicant: LIANG-HAO WEI, Taipei City (TW)

(72) Inventor: LIANG-HAO WEI, Taipei City (TW)

(21) Appl. No.: 13/714,407

(22) Filed: Dec. 14, 2012

(30) Foreign Application Priority Data
Dec. 22, 2011 (TW) 100147913

(51) Int. Cl. B05D 5/00

(52) U.S. Cl. CPC B05D 5/00
USPC 427/258

(57) ABSTRACT

A method for manufacturing a material of energy product includes sufficiently stirring and mixing a naturally-mixed rare earth mineral of 25%-35% with a water-soluble essence of 65%-75% to form a base material for printing; setting up a print plate on a screen printing machine to carry out printing of the base material, followed by baking and drying, in a layer by layer manner with each layer being of a thickness of 0.04 mm; and repeating the steps of printing and baking and drying for several times to form an energy product material of an increased thickness that is applicable to decorations, textiles, personal daily commodities, and rehabilitation articles to provide a user with protection against adverse influences caused by positive ions, maintain natural balance of the body of the user, and facilitate blood circulation of the body of the user to thus improve metabolism.

### TECHNICAL FIELD OF THE INVENTION

The present invention generally relates to a method for manufacturing material of energy product, and more particularly to a method for manufacturing an energy product material that is applicable to decorations, textiles, personal daily commodities, and rehabilitation articles.

### DESCRIPTION OF THE PRIOR ART

Due to the development of science and technology, the living environments and bodies of human being are susceptible to the following risks:

(1) In urban areas that are full of buildings, a great amount of positive ions exists. Television sets, computers, microwave ovens, and electrical products all give off electromagnetic waves and generates a lot of positive ions. The positive ion is also referred to as exhaustion ion. When a person is exposed to an environment containing a great amount of positive ions, the person is susceptible to tiredness both physically and mentally. Studies reveal that positive ion deteriorates the performance of body immune system, affects circulation of blood, and accelerates the aging process.

(2) There is minute electrical current flowing in human body and information transmission from top to bottom and from whole body to the brain is generally dependent on the flow of bioelectric current. For a person of perfect health with no vexation and pressures, the body current is flowing in an orderly manner inside the body. However, in reality, the number of persons of perfect health is extremely small. This is particularly true for modern people, who are subjected to long term psychological stress and impact of electromagnetic waves emitting from electronic products such as computers, so that the body current is generally disordered, making people frequently feel exhausted.

(3) Diseases of civilization that often affect the modern people mostly result from disorder of peripheral blood circulation, which means poor circulation of blood that leads to for example low temperature and paralysis occurring in extremes. Blood circulation is a condition where blood flows through vessels. Metabolism is a phenomenon that body cells discharge wastes of respiration (such as carbon dioxide) into the blood and absorb fresh oxygen, saccharide, and nutrition from the blood to supply energy to the cells. For people with poor blood circulation, the performance of metabolism also gets poor. This is because the slow flow of blood makes the exchange of waste and nutrition lowered.

Health-care energy products made of mineral materials are available in the market to improve the above problem by being put on by a user. However, as shown in FIG. 1, the conventional product is manufactured by mixing silicone gel 1 (or manufacturing by means of other plastic materials) with mineral materials 2 to form the energy product. Since the mineral material 2 has a relatively high density and has melting point that is generally greater than 2,000° C., mixing cannot be conducted easily and consequently, after the mixing operation with various carrier medium materials, the carrier silicone gel 1 (plastics) often gets present on an upper layer, while the mineral material 2 settles down on the bottom. This results in instability of product quality and causes a great loss of material in the manufacturing process. In view of these problems, the present invention aims to provide a method for manufacturing material of energy product that helps providing stable quality of the material of energy product.

### SUMMARY OF THE INVENTION

The primary object of the present invention is to provide a method for manufacturing material of energy product that makes the quality of the energy product material stable for easy application to decorations, textiles, personal daily commodities, and rehabilitation articles to improve the quality of these products.

The method for manufacturing a material of energy product described above comprises the steps of sufficiently stirring and mixing a naturally-mixed rare earth mineral of 25%-35% with a water-soluble essence of 65%-75% to form a base material for printing; setting up a print plate on a screen printing machine to carry out printing of the base material, followed by baking and drying, in a layer by layer manner with each layer being of a thickness of 0.04 mm; and repeating the steps of printing and baking and drying for several times to form an energy product material of an increased thickness that is applicable to decorations, textiles, personal daily commodities, and rehabilitation articles to provide a user with protection against adverse influences caused by positive ions, maintain natural balance of the body of the user, and facilitate blood circulation of the body of the user to thus improve metabolism.

In the method for manufacturing energy product material described above, the step of baking and drying is carried out with a moderate temperature oven for at least 5 minutes of the baking and drying so as to keep the mineral materials in predetermined ones of the layers without sedimentation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view showing a conventional material for energy product.

FIG. 2 is a schematic view illustrating the manufacturing of the present invention.

FIG. 3 is a flow chart of the manufacturing of the present invention.

FIG. 4 is a cross-sectional view of the energy product material according to the present invention.

FIG. 5 is a schematic view showing an example energy product made of the material according to the present invention.

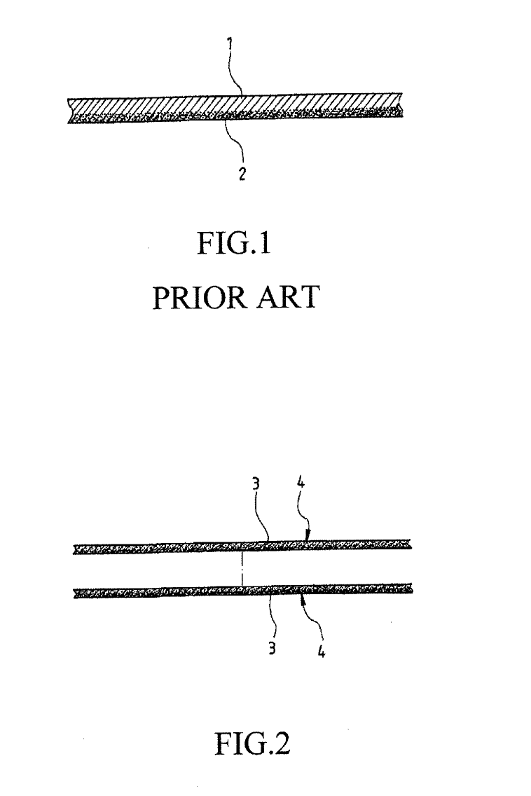

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

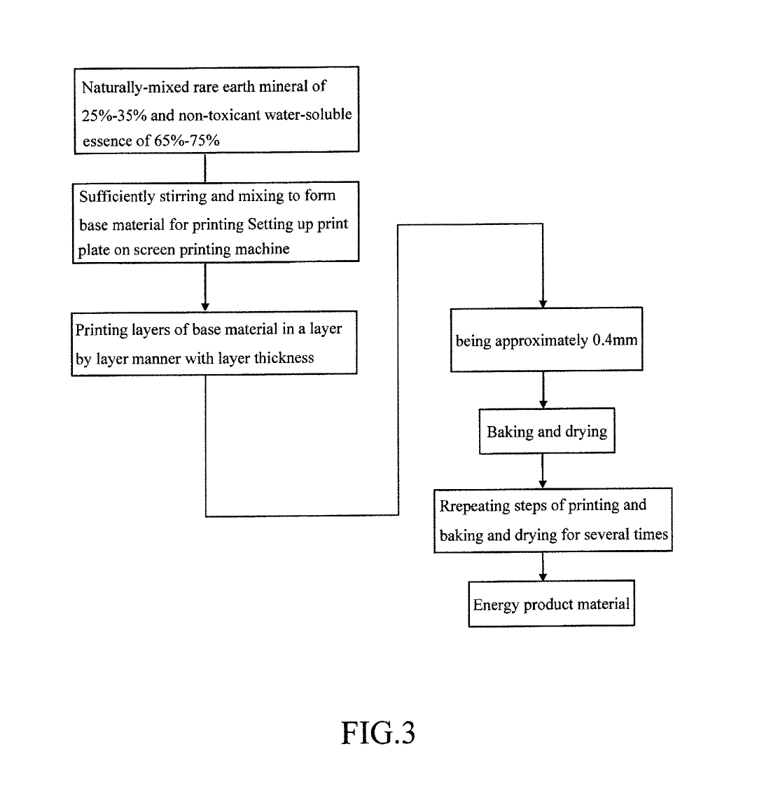

Referring to both FIGS. 2 and 3, a schematic view illustrating the manufacturing of the present invention and a flow chart of the manufacturing of the present invention are shown. As shown in the drawings, the flow of manufacturing according to the present invention comprises the following steps:

(1) sufficiently stirring and mixing a naturally-mixed rare earth mineral (mineral material 3) of 25%-35% with a non-toxicant water-soluble essence of 65%-75% to form a base material 4 for printing;

(2) setting up a print plate on a screen printing machine to identify the pattern and size of a printing surface;

(3) printing layers of the base material 4 having a thickness of approximately 0.04 mm by means of the screen printing machine so that the thickness of each layer is controlled at 0.04 mm;

(4) after completing the printing of each layer, carrying out baking and drying with a moderate temperature oven, wherein the time period for baking and drying is at least 5 minutes so as to ensure that the mineral material 3 is set in predetermined ones of the layers after combination of the layers without undesired sedimentation thereby ensuring the quality; and

(5) repeating steps (3)-(4) for several times (preferably, 12 times) according to the requirements for product in order to increase the overall thickness (which is preferably 0.5 mm) for forming a material A for energy products.

For the energy product material A so manufactured with the method, since the non-toxicant water-soluble essence, after being baked and dried, shows certain toughness, it is possible to be applied to decorations, textiles, personal daily commodities, and rehabilitation articles to provide a user with protection against adverse influence caused by positive ions, maintain natural balance of the body of the user, and prompt blood circulation of the users for improving metabolism.

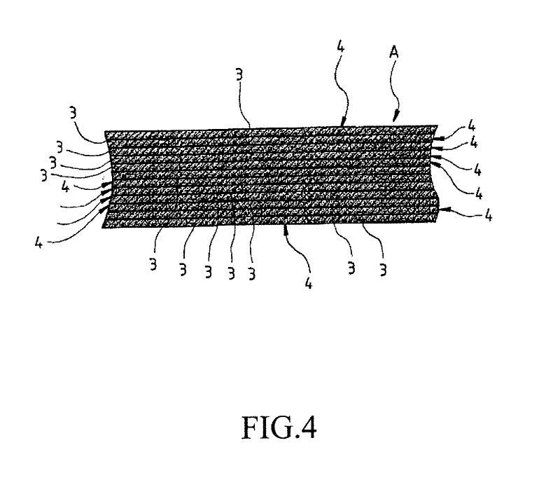

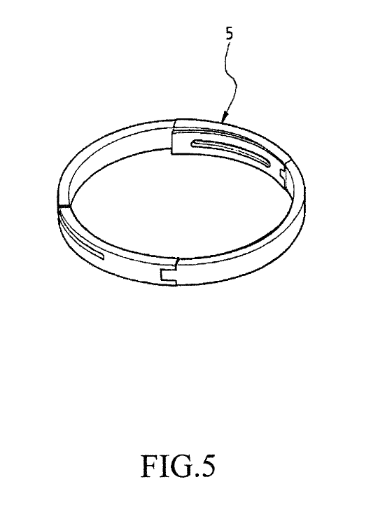

Referring to FIG. 4, a cross-sectional view of the energy product material according to the present invention is given. As shown in the drawing, the energy product material A manufactured with the present invention is formed through printing layer by layer so that in the structure thereof so formed, the mineral material 3 is present in each layer of the base material 4. Although sediment to certain extent may exist, yet the contents of the mineral material 3 in each layer can be properly maintained. Further, it is non-toxicant and thus safe and the energy products made with the material can be more stable in quality.

Referring to FIG. 5, a schematic view showing an example energy product made of the material according to the present invention is given. As shown in the drawing, the energy product material of the present invention can be used to manufacture decorations, textiles, personal daily commodities, and rehabilitation articles. The example shown in FIG. 5 is a wrist ring decoration, which can be put on a hand. The energy product manufactured with the material can provide at least the following health caring functions:

(1) Negative ions contained in an energy product made of the material according to the present invention can help protecting against adverse influences caused by positive ions and prevent positive ions from deteriorating the performance of body immune system, affecting blood circulation, and accelerating the aging process.

(2) An energy product made of the material according to the present invention helps regulating and stabilizing disordered bioelectric current flowing inside human body so as to make the bioelectric current to flow orderly inside the human body with the advantages of making muscles tender to smoothen motion of body and also causes beneficial physiological effect on human body to help maintain the best health condition and keep natural balance of human body.

(3) The rare earth mineral contained in an energy product made of the material according to the present invention releases far infrared light that may facilitate blood circulation and improve metabolism, helping cells of human body to discharge wastes of for example respiration (such as carbon dioxide) into blood and to absorb fresh oxygen, saccharide, and nutrition from the blood to supply energy to the cells so as to accelerates metabolism and speed up blood flow to improve exchange between waste and nutrition.

In summary, the present invention provides a base material that is formed by sufficiently stirring and mixing natural rare earth mineral with a water-soluble essence. The base material is printed and baked and dried in a layer by layer manner to form a material for energy product. The mineral material is thus maintained in each layer of the base material and each layer can have a stable content of mineral material. This energy product material is generally non-toxicant and the energy product made with such a material may show quality that is more stable.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for manufacturing a material of energy product, comprising the following steps:
(a) sufficiently stirring and mixing a naturally-mixed rare earth mineral of 25%-35% with a water-soluble essence of 65%-75% to form a base material for printing
(b) setting up a print plate on a screen printing machine to identify the pattern and size of a printing surface;
(c) printing layers of the base material by means of the screen printing machine in a layer by layer manner;
(d) after completing the printing of each layer, carry out baking and drying with a moderate temperature oven; and
(5) repeating steps (c)-(d) for several times in order to increase the overall thickness for forming an energy product material that is applicable to decorations, textiles, personal daily commodities, and rehabilitation articles.

2. The method for manufacturing a material of energy product according to claim 1, wherein each of the layers printed with the screen printing machine has a thickness that is controlled to be 0.04 mm.

3. The method for manufacturing a material of energy product according to claim 1, wherein time period of baking and drying carried out after each of the layers is printed is at least 5 minutes in order to ensure that the mineral material is set in predetermined one of the layers after combination of the layers without sedimentation thereby ensuring the quality.

4. The method for manufacturing a material of energy product according to claim 1, wherein the water soluble essence that is mixed with the naturally-mixed rare earth mineral is non-toxicant.

5. The method for manufacturing a material of energy product according to claim 1, wherein the number of the layers printed in 12.

6. The method for manufacturing a material of energy product according to claim 1, wherein the overall thickness of the printed layers is 0.5 mm.
